(19) United States
(12) Patent Application Publication
(10) Pub. No.: US 2006/0209534 A1
(43) Pub. Date: Sep. 21, 2006

(54) Candle light decoration with an LED inside

(76) Inventor: Yu Peng Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/080,394

(22) Filed: Mar. 16, 2005

(51) Int. Cl. F21V 35/00

(52) U.S. Cl. 362/161

(57) ABSTRACT

The invention relates to a candle light decoration, which mainly uses an LED in a C-type shell connecting with a candle-shaped support for lighting. The use of this decoration is more secure and economic, since LED needs low power and occurs low temperature. Furthermore, the C-type shell with LED inside can be applied in many other embodiments.

### FIELD OF THE INVENTION

The present invention relates to an improvement of a candle light decoration, which is provided with an LED inside for lighting to obtain secure and economic purpose.

### BACKGROUND OF THE INVENTION

In prior art, a candle light decoration always includes a candle-shaped support and a C-type lamp to form a lighting decoration just as a candle in special situation. The known C-type lamp has inner tungsten to emit light when it is conducted and heated. In this manner, the C-type lamp occurs high temperature that will be dangerous. Moreover, the C-type lamp needs more power to be lightened that wastes electrical source and cost.

### SUMMARY OF THE INVENTION

The present invention is to provide a candle light decoration, which includes a C-type shell and an LED inside to instead the known C-type lamp that provides improvement and overcomes prior drawbacks. Now, accompanying with the following drawings, the character of the present invention will be described here and after.

### BRIEF DESCRIPTION OF THE DRAWINGS

FIG. 1 is a perspective view showing a lamp of a candle light decoration according to the present invention.

FIG. 2 is a cross-sectional plan view of FIG. 1.

FIG. 3 is a plan view showing a candle light decoration with DC power supply according to the present invention.

FIG. 4 is a plan view showing a candle light decoration with AC power supply according to the present invention.

### DETAILED DESCRIPTION OF THE PREFERRED EMBODIMENT

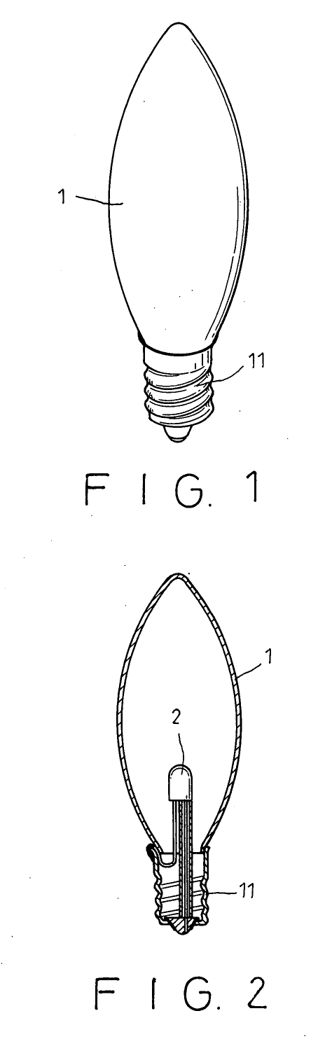

Please refer to FIG. 1 and 2, the present invention relates to an improvement of a candle light decoration, which includes a C-type shell (1), and a candle-shaped support (3). The shell (1) is provided with a connector (11) to engage with top of the support (3) that forms a configuration as a real candle in burning. The improvement of the present invention is to provide at least one LED (2) in the shell (1), wherein the LED (2) includes two legs being connected with both poles (positive and negative) of the connector (11).

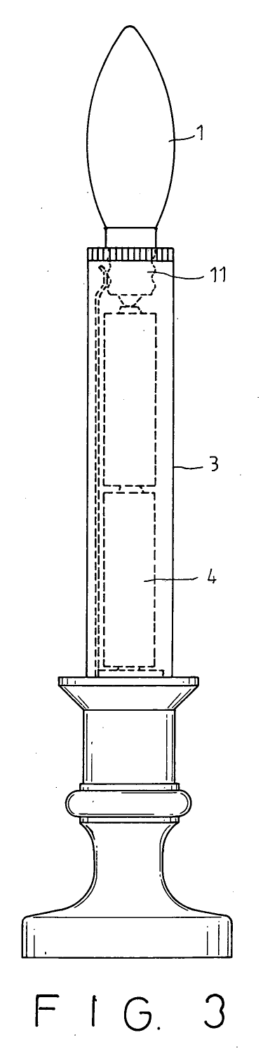

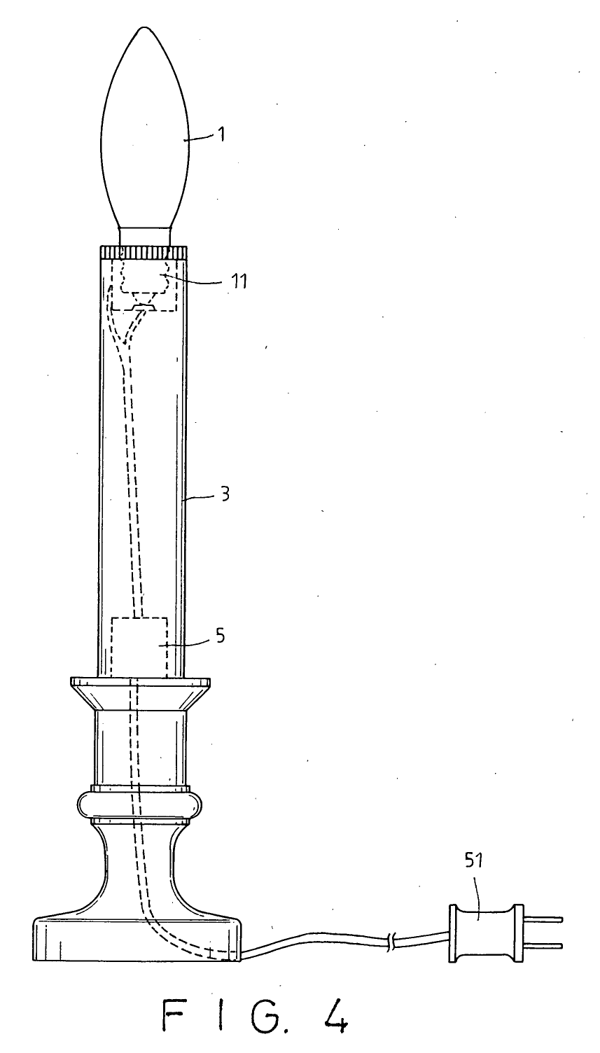

In use, whenever it uses batteries (4) for DC power supply, as shown in FIG. 3, or uses a transformer (5) to transfer AC current from plug (51) to DC current, the LED (2) can be lightened to emit light. The LED (2) will not cause high temperature and the needed power is low. The present invention is then economic and secure when uses.

Accordingly, the present invention provides invented and noble improvement that should be allowed for patent. But the above embodiment is only an exemplary; in fact, it can be applied in any other scope similar to this invention, just including a C-type shell with LED inside.

I claim:

1. A candle light decoration with LED inside including a C-type shell, and a candle-shaped support, wherein the shell being provided with a connector to engage with top of the support; the improvement is to provide at least one LED in the shell, wherein the LED includes two legs being connected with both poles of the connector and emits light as being conducted.

2. A candle light decoration with LED inside as claimed in claim 1, wherein the decoration having various shape is connected with a C-type shell with at least one LED inside.
